(19) United States
(12) Patent Application Publication
(10) Pub. No.: US 2026/0136186 A1
(43) Pub. Date: May 14, 2026

(54) TECHNIQUE FOR AUTHENTICATING SUBSCRIBERS ON VISITED NETWORKS

(71) Applicant: Charter Communications Operating, LLC, St. Louis, MO (US)

(72) Inventor: Peter Andrew Ericksen, Castle Rock, CO (US)

(73) Assignee: Charter Communications Operating, LLC, St. Louis, MO (US)

(21) Appl. No.: 18/945,037

(22) Filed: Nov. 12, 2024

(51) Int. Cl. H04W 12/06; H04W 12/72

(52) U.S. Cl. CPC H04W 12/068; H04W 12/72

(57) ABSTRACT

The home network operated by a subscribed service provider receives a request from a visited network having a network sharing relationship with the home network for access to the visited network by user equipment (UE) of a subscriber to the home network, where the request identifies device-specific credentials (e.g., username and password) for the UE that are different from the subscriber's credentials; determines whether the device-specific credentials correspond to an active device and an active subscriber; and, upon determining that the device-specific credentials correspond to an active device and an active subscriber, transmits an access-acceptance response to the visited network. Using device-specific credentials allows access at the visited network to be limited, e.g., to only Internet access, thereby preventing unauthorized third parties from gaining access to other services, such as video streaming and gaming, available to subscribers from their home network.

### BACKGROUND

### Field of the Disclosure

The present disclosure relates to wireless communications and, more specifically but not exclusively, to allowing subscribers access to the Internet via non-subscribed wireless networks.

### Description of the Related Art

This section introduces aspects that may help facilitate a better understanding of the disclosure. Accordingly, the statements of this section are to be read in this light and are not to be understood as admissions about what is prior art or what is not prior art.

It is known for a wireless service provider to provide its subscribers with access to the Internet and other supported services, such as video streaming and gaming, via WiFi and/or other wireless local area networks (WLANs) operated by the subscribed service provider. In that case, a subscriber uses their smart phone, tablet, or other suitable wireless device (aka user equipment or UE, for short) to transmit their username and password to an access point (AP) of such a WLAN to gain access to those services.

It is also known for a subscribed service provider to have a network sharing relationship with another (i.e., non-subscribed) service provider that enables subscribers to access the Internet via WLANs operated by the non-subscribed service provider. Here, too, the subscriber uses their UE to transmit their username and password to an AP of a non-subscribed WLAN to gain access to the Internet via that WLAN. Unfortunately, if the subscriber's username and password get intercepted by an unauthorized third party, then that unauthorized third party can gain access to the other services, such as video streaming and gaming, provided by the subscribed service provider at the expense of either the subscriber or the subscribed service provider or both.

As used herein, the term “home network” refers to the infrastructure of a service provider to which a user is a subscriber, and the term “visited network” refers to the infrastructure of a service provider to which that user is not a subscriber, where the service provider of the home network has an appropriate network sharing relationship with the service provider of the visited network.

### SUMMARY

Problems in the prior art are addressed in accordance with the principles of the present disclosure by techniques that prevent unauthorized third parties from gaining access to services, such as video streaming and gaming, provided by a subscribed service provider due to the interception of a subscriber's username and password when the subscriber attempts to gain Internet access via a visited network of a non-subscribed service provider having a network sharing relationship with the subscribed service provider. In certain embodiments, the techniques involve storing a device-specific username and password on a subscriber's UE that are different from the subscriber's conventional username and password. The device-specific username and password limit access via the visited network by that UE to only the Internet and not to other services, such as video streaming and gaming, provided by the subscribed service provider to the subscriber via the service provider's home network. As such, if the device-specific username and password get intercepted by an unauthorized third party, that third party will be able to use that username and password to gain only Internet access and not access to other services, such as video streaming and gaming, provided by the subscribed service provider, thereby avoiding the expense of such unauthorized access to the subscriber and/or the subscribed service provider.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified, combined block diagram/flow diagram illustrating the infrastructure and processing according to certain embodiments of the disclosure;

FIG. 2 is a schema representation of the data objects and attributes that are stored in a database in the IAM of FIG. 1;

FIG. 3 is a logical representation of the User and UserDevice objects of FIG. 2 as stored in the IAM database with relevant attributes shown assigned as appropriate; and

FIG. 4 is a simplified hardware block diagram of the home network of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

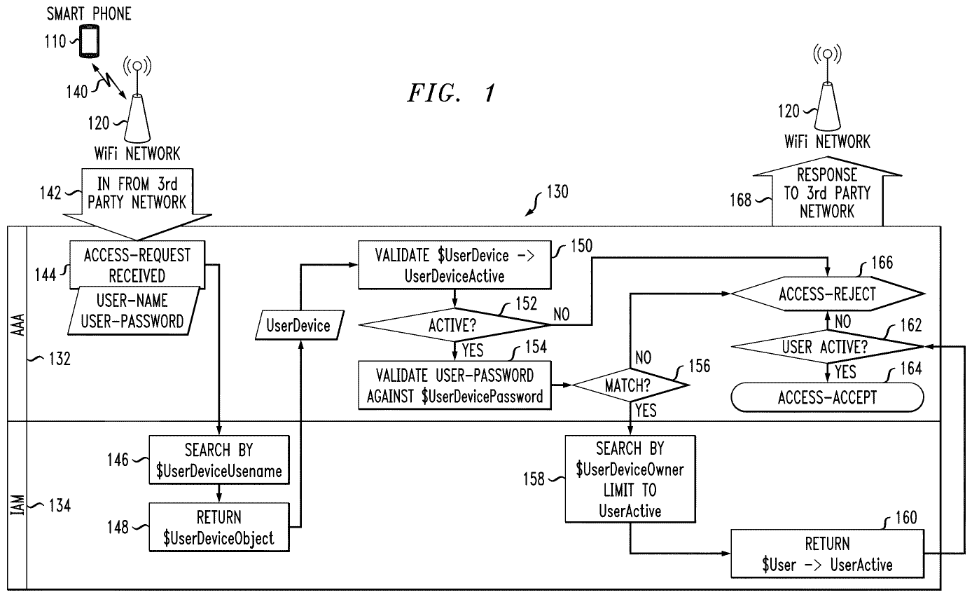

FIG. 1 is a simplified, combined block diagram/flow diagram illustrating the infrastructure and processing according to certain embodiments of the disclosure. In terms of infrastructure, FIG. 1 shows a user's UE (in this case, a smart phone) 110, a visited network (in this case, a WiFi network) 120 (represented twice in FIG. 1) operated by a non-subscribed service provider to which the user is not a subscriber, and a home network 130 operated by a service provider to which the user is a subscriber, where the subscribed service provider has a network sharing relationship with the non-subscribed service provider that provides subscribers of the subscribed service provider with access to the Internet via the visited network 120 operated by the non-subscribed service provider. As shown in FIG. 1, the home network 130 includes an Authentication, Authorization, and Accounting (AAA) server 132 and an Identity and Access Management (IAM) server 134.

According to certain embodiments of the disclosure, the user's UE 110 has stored on it a device-specific username and password that are different from the user's conventional username and password and which were previously assigned to the UE 110 by the home network 130 and stored in the home network's IAM server 134. In some implementations, the device-specific username and password are stored in a passpoint profile on the UE 110. In other implementations, the user may manually enter their device-specific username and password into the UE 110. Note that, for implementations that employ a passpoint profile, the user might not even know the UE's device-specific username and password.

In terms of processing, in step 140, the user uses their UE 110 to communicate with the visited network 120 to request Internet access. As part of that communication and depending on the implementation, the device-specific username and password stored in the UE's passpoint profile are automatically transmitted to the visited network 120 or the user uses their UE 110 to manually enter and transmit the device-specific username and password to the visited network 120.

In response, in step 142, the visited network 120 recognizes that the user is a subscriber of the service provider of the home network 130 and transmits, to the home network 130 via backend communications, an access request (e.g., an industry-standard RADIUS Access Request) to allow the UE 110 Internet access via the visited network 120, where the access request includes the device-specific username and password received from the UE 110. In step 144, that access request is received at the home network's AAA server 132, which extracts the device-specific username and password from the access request.

In step 146, using the received device-specific username, the AAA server 132 performs a search in a database maintained at the home network's IAM server 134. In response, in step 148, the IAM server 134 returns to the AAA server 132 a corresponding device data object retrieved from that IAM database, where the retrieved device data object identifies the UE 110.

In step 150, the AAA server 132 performs a validation operation to determine whether the UE 110 is an active device, where “active” means that the UE 110 is owned by a current subscriber of the service provider of the home network 130. If not (step 152), then, in step 166, the AAA server 132 determines that the access request should be denied.

If, however, the AAA server 132 determines, in step 152, that the UE 110 is an active device (e.g., not lost or stolen), then, in step 154, the AAA server 132 performs a validation operation to determine, in step 156, whether the device-specific password received from the UE 110 via the visited network 120 matches the password assigned to the UE 110 and stored in the AAA server 132. If not, then, in step 166, the AAA server 132 again determines that the access request should be denied.

If, however, the AAA server 132 determines, in step 156, that the received device-specific password matches the retrieved password, then, in step 158, using the received device-specific username, the AAA server 132 performs a search in a database maintained at the home network's IAM server 134. In response, in step 160, the IAM server 134 returns to the AAA server 132 a corresponding access data object retrieved from that IAM database, where the retrieved access data object identifies whether Internet access is available to the UE 110.

In step 162, based on the response from the IAM server 134, the AAA server 132 determines whether the UE's owner is an active subscriber (i.e., not suspended, etc.). If not, then, in step 166, the AAA server 132 again determines that the access request should be denied. Otherwise, in step 164, the AAA server 132 determines that the access request should be accepted.

In step 168, depending on whether step 164 or step 166 was reached, the AAA server 132 transmits to the visited network 120 a corresponding response indicating whether or not the UE 110 should be granted Internet access. Although not represented in FIG. 1, the visited network 120 then informs the user's UE 110 of the decision and, if the request is accepted, then the visited network 120 provides the UE 110 with Internet access, but not access to other services available from the subscribed service provider to its subscribers.

In this way, subscribers are granted Internet access at visited networks without risking unauthorized third parties intercepting the user's conventional username and password and gaining access to other services, such as video streaming and gaming, provided by the subscribed service provider, thereby avoiding the expense of such unauthorized access to the subscriber and/or the subscribed service provider.

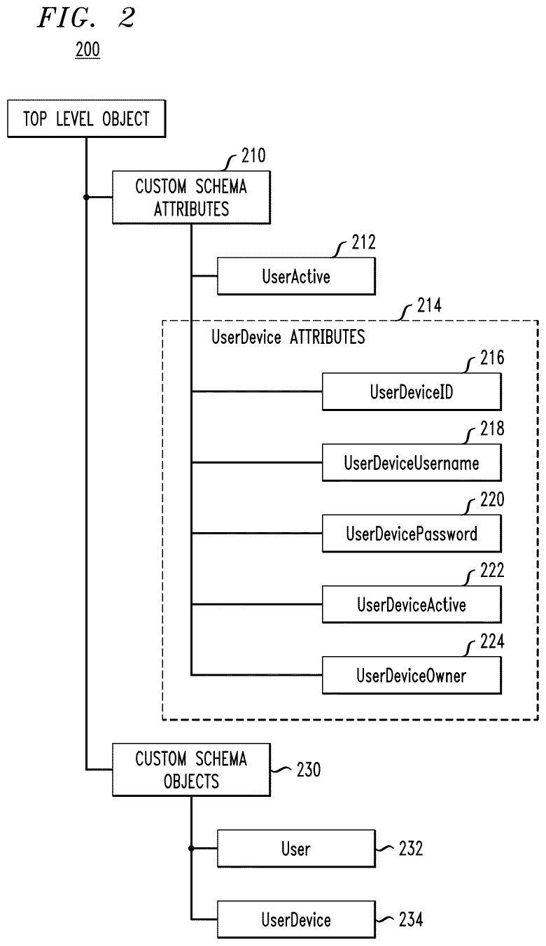

FIG. 2 is a schema representation of the data objects 230 and attributes 210 that are stored in a database 200 in the IAM 134. The User object 232 is a representation of the user as stored in the IAM 134. The UserDevice object 234 is a representation of the UE 110 as stored in the IAM 134. The remaining attributes 212-224 are representations of attributes that are assigned to the User object 232 or UserDevice object 234 as stored in the IAM 134.

FIG. 3 is a logical representation of User and UserDevice objects 232 and 234 as stored in the IAM database 200 with relevant attributes 212-224 shown assigned as appropriate.

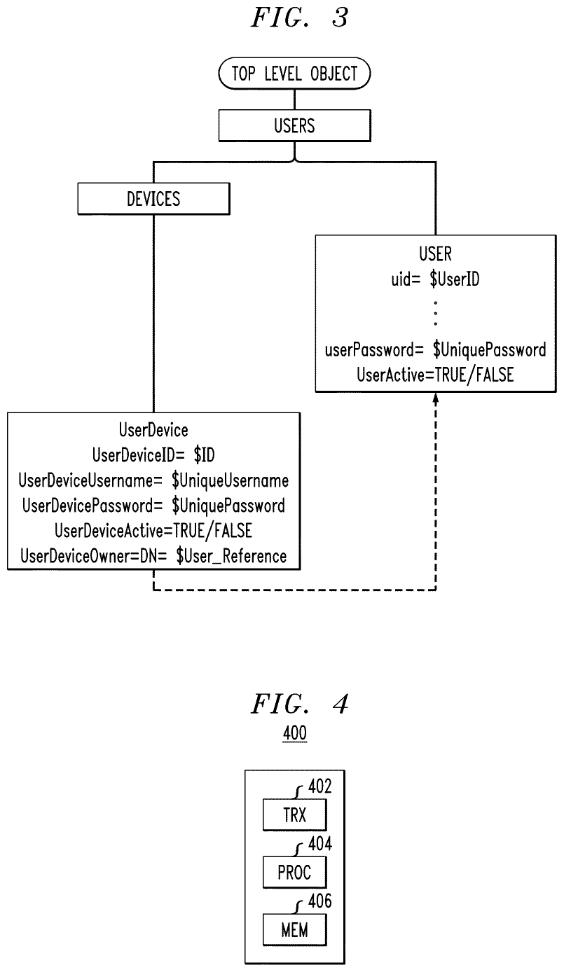

FIG. 4 is a simplified hardware block diagram of the home network 130 of FIG. 1. As shown in FIG. 4, the home network 130 includes (i) communication hardware (e.g., wireless, wireline, and/or optical transceivers (TRX)) 402 that supports communications with the visited network, (ii) one or more processors (e.g., CPU and/or GPU microprocessors) 404 that control the operations of the home network 130 and/or process data within the home network 130, and (iii) one or more memories (e.g., RAM, ROM) 406 that store code executed by the processors 404 and/or data generated and/or received by the home network 130. Note that the visited network 120 of FIG. 1 may be implemented using analogous configurations of communication hardware, processors, and memories.

Although the present disclosure has been described in the context of techniques for allowing a subscriber only Internet access at visited networks, in general, the present disclosure involves techniques for allowing subscribers access to only a specified subset of the larger range of services available to the subscriber at their home network, where that specified subset might or might not include Internet access.

Although the present disclosure has been described in the context of a visited network that is a WiFi network that requires a username and a password for access, in general, the present disclosure may be implemented in the context of any suitable wireless network that requires any suitable set of identification information (aka credentials), where those credentials might or might not include a username and/r a password.

In certain embodiments, the present disclosure is a home network comprising a memory and at least one processor, coupled to the memory and operative to implement an authentication, authorization, and accounting (AAA) server and an identity and access management (IAM) server. The AAA server is adapted to receive a request from a visited network having a network sharing relationship with the home network for access to the visited network by user equipment (UE) of a subscriber to the home network, wherein the request identifies device-specific credentials for the UE that are different from the subscriber's credentials. The AAA server is adapted to communicate with the IAM server to determine whether the device-specific credentials correspond to an active device and an active subscriber. Upon determining that the device-specific credentials correspond to an active device and an active subscriber, the AAA server is adapted to transmit an access-acceptance response to the visited network.

In at least some of the above embodiments, wherein, upon determining that the device-specific credentials correspond to an inactive device and/or an inactive subscriber, the AAA server is adapted to transmit an access-rejection response to the visited network.

In at least some of the above embodiments, the device-specific credentials are stored on the UE.

In at least some of the above embodiments, the device-specific credentials are stored in a passpoint profile on the UE.

In at least some of the above embodiments, the home network is adapted to receive a request to generate the device-specific credentials for the UE and store the device-specific credentials both at the home network and on the UE.

In at least some of the above embodiments, the home network is adapted to store the device-specific credentials in a passpoint profile stored on the UE.

In at least some of the above embodiments, the access to the visited network is limited to a subset of services available to the subscriber from the home network.

In at least some of the above embodiments, the subset of services comprises Internet access.

In at least some of the above embodiments, the subset of services comprises only Internet access.

In at least some of the above embodiments, the device-specific credentials include (i) a device-specific username different from the subscriber's username and (ii) a device-specific password different from the subscriber's password.

In at least some of the above embodiments, the visited network is a WiFi network.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A home network comprising a memory and at least one processor, coupled to the memory and operative to implement:
an authentication, authorization, and accounting (AAA) server; and
an identity and access management (IAM) server, wherein:
the AAA server is adapted to receive a request from a visited network having a network sharing relationship with the home network for access to the visited network by user equipment (UE) of a subscriber to the home network, wherein the request identifies device-specific credentials for the UE that are different from the subscriber's credentials;
the AAA server is adapted to communicate with the IAM server to determine whether the device-specific credentials correspond to an active device and an active subscriber; and
upon determining that the device-specific credentials correspond to an active device and an active subscriber, the AAA server is adapted to transmit an access-acceptance response to the visited network.

2. The home network of claim 1, wherein, upon determining that the device-specific credentials correspond to an inactive device and/or an inactive subscriber, the AAA server is adapted to transmit an access-rejection response to the visited network.

3. The home network of claim 1, wherein the device-specific credentials are stored on the UE.

4. The home network of claim 3, wherein the device-specific credentials are stored in a passpoint profile on the UE.

5. The home network of claim 3, wherein the home network is adapted to:
receive a request to generate the device-specific credentials for the UE; and
store the device-specific credentials both at the home network and on the UE.

6. The home network of claim 5, wherein the home network is adapted to store the device-specific credentials in a passpoint profile stored on the UE.

7. The home network of claim 1, wherein the access to the visited network is limited to a subset of services available to the subscriber from the home network.

8. The home network of claim 7, wherein the subset of services comprises Internet access.

9. The home network of claim 8, wherein the subset of services comprises only Internet access.

10. The home network of claim 1, wherein the device-specific credentials include (i) a device-specific username different from the subscriber's username and (ii) a device-specific password different from the subscriber's password.

11. The home network of claim 1, wherein the visited network is a WiFi network.

12. A method for a home network, the method comprising the home network:
receiving a request from a visited network having a network sharing relationship with the home network for access to the visited network by user equipment (UE) of a subscriber to the home network, wherein the request identifies device-specific credentials for the UE that are different from the subscriber's credentials;
determining whether the device-specific credentials correspond to an active device and an active subscriber; and
upon determining that the device-specific credentials correspond to an active device and an active subscriber, transmitting an access-acceptance response to the visited network.

13. The method of claim 12, wherein, upon determining that the device-specific credentials correspond to an inactive device and/or an inactive subscriber, the AAA server transmits an access-rejection response to the visited network.

14. The method of claim 12, wherein the device-specific credentials are stored on the UE.

15. The method of claim 14, wherein the device-specific credentials are stored in a passpoint profile on the UE.

16. The method of claim 14, wherein the home network:
receives a request to generate the device-specific credentials for the UE; and
stores the device-specific credentials both at the home network and on the UE.

17. The method of claim 16, wherein the home network stores the device-specific credentials in a passpoint profile stored on the UE.

18. The method of claim 12, wherein the access to the visited network is limited to a subset of services available to the subscriber from the home network.

19. The method of claim 18, wherein the subset of services comprises Internet access.

20. The method of claim 19, wherein the subset of services comprises only Internet access.

21. The method of claim 12, wherein the device-specific credentials include (i) a device-specific username different from the subscriber's username and (ii) a device-specific password different from the subscriber's password.

22. The method of claim 12, wherein the visited network is a WiFi network.
